(19) United States
(12) Patent Application Publication
(10) Pub. No.: US 2023/0161529 A1
(43) Pub. Date: May 25, 2023

(54) IMAGE FORMING APPARATUS, IMAGE FORMING SYSTEM, AND STORAGE MEDIUM

(71) Applicant: CANON KABUSHIKI KAISHA, Tokyo (JP)

(72) Inventor: HIROSHI OYA, Tokyo (JP)

(21) Appl. No.: 18/056,619

(22) Filed: Nov. 17, 2022

(30) Foreign Application Priority Data
Nov. 22, 2021 (JP) 2021-189279

(51) Int. Cl. G06F 3/12

(52) U.S. Cl. CPC G06F 3/1257; G06F 3/1255

(57) ABSTRACT

An image forming apparatus includes a reception unit and a control unit. The reception unit receives print data. The control unit performs control to display, on a display unit, a sheet setting method for setting a sheet to be used to print the print data, based on a state where a predetermined setting is included in the received print data.

### BACKGROUND

### Field

The present disclosure relates to an image forming apparatus, an image forming system, and a storage medium.

### Description of the Related Art

Japanese Patent Application Laid-Open No. 2020-113060 discusses a technique for, when image data converted by a printer driver on a personal computer (PC) is printed, displaying on the screen of the PC a sheet setting method associated with a sheet size and a sheet type that are set.

In some cases, when a package is delivered, image data on an invoice to be used in the delivery is created on a PC and printed by a printer. In this case, a sheet adapted to a format specific to a carrying company (hereinafter referred to as an “invoice sheet”) is used. The sheet size and the sheet type of the invoice sheet are unique. Frame lines are printed in advance on the sheet, which involves setting the invoice sheet in the correct orientation. A setting method for setting the invoice sheet, however, is confusing to a general user, and an error in printing is likely to occur. In Japanese Patent Application Laid-Open No. 2020-113060, the sheet setting method is displayed on the screen alone of the PC, which makes a user go back and forth between the PC and a printer. This causes the user such trouble and is a burden on the user.

### SUMMARY

The present disclosure is directed to reduction of the burden on a user in printing for a predetermined purpose.

According to an aspect of the present disclosure, an image forming apparatus includes a reception unit configured to receive print data, and a control unit configured to perform control to display, on a display unit, a sheet setting method for setting a sheet to be used to print the print data, based on a state where a predetermined setting is included in the received print data.

Further features of the present disclosure will become apparent from the following description of exemplary embodiments with reference to the attached drawings.

### BRIEF DESCRIPTION OF THE DRAWINGS

FIG. 1A illustrates an example of the configuration of an image forming system.

FIGS. 1BA and 1BB illustrate examples of the configurations of apparatuses included in the image forming system.

FIG. 2 illustrates a sequence for transmitting an invoice print job.

FIGS. 3A to 3D illustrate examples of display of screens displayed on an information processing apparatus.

FIG. 4 is a flowchart illustrating an invoice printing process.

FIG. 5 illustrates an example of display of a screen displayed on an image forming apparatus.

FIG. 6 illustrates an example of display of a screen displayed on the image forming apparatus.

FIG. 7 illustrates an example of an invoice print condition table.

FIG. 8 illustrates an example of display of a screen displayed on the image forming apparatus.

FIG. 9 illustrates a sequence for transmitting an invoice print job.

FIG. 10 illustrates an example of display of a screen displayed on the information processing apparatus.

### DESCRIPTION OF THE EMBODIMENTS

With reference to the drawings, some exemplary embodiments for implementing the present disclosure will be described below.

### <Configuration of Image Forming System>

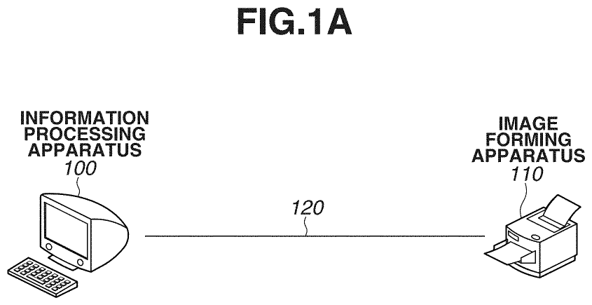

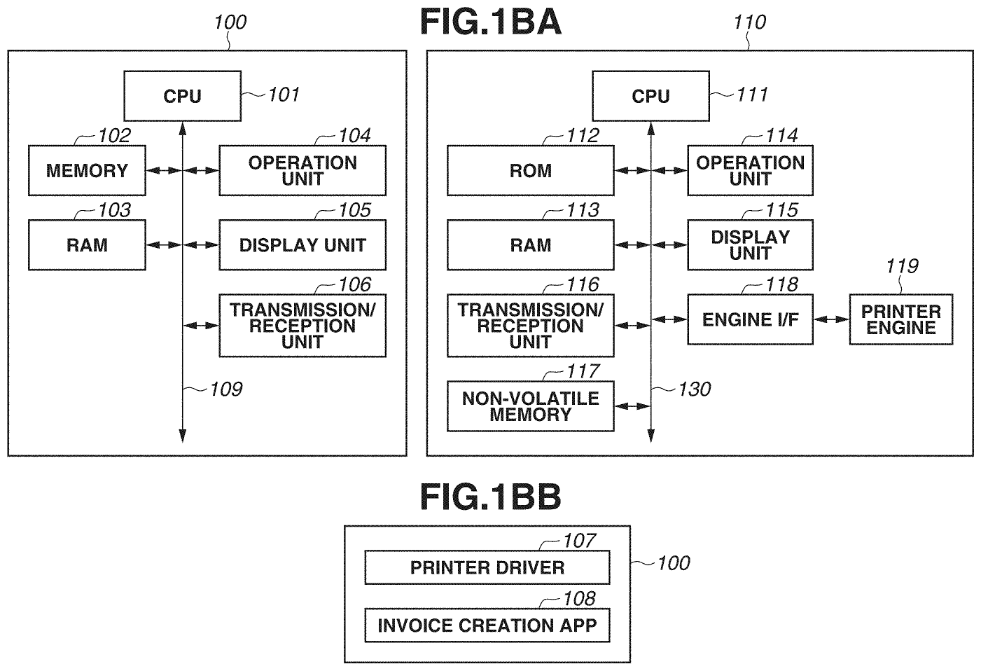

A first exemplary embodiment will be described. FIG. 1A illustrates an example of the configuration of an image forming system according to the present exemplary embodiment. As illustrated in FIG. 1A, the image forming system includes an information processing apparatus 100 and an image forming apparatus 110. The information processing apparatus 100 is connected to the image forming apparatus 110 via a wired or wireless network 120. The information processing apparatus 100 is a computer apparatus such as a personal computer (PC), a smartphone, or a tablet terminal apparatus. According to instructions from the information processing apparatus 100, the image forming apparatus 110 performs printing. The image forming apparatus 110 is not particularly limited so long as the image forming apparatus 110 is an image forming apparatus including an image forming unit, such as a copying machine, a multifunction peripheral, a printer, or a facsimile, regardless of whether a mono-color image forming apparatus or a full-color image forming apparatus. The following description will be given on the assumption that the image forming apparatus 110 is a printer specialized in a print function.

In the present exemplary embodiment, a case is described where, when a package is sent to a destination through the use of a service provided by a carrying company using the image forming system illustrated in FIG. 1A, an invoice to be attached to the package is printed. In this case, a sheet adapted to a format specific to the carrying company (an invoice sheet) is used. The sheet size and the sheet type of the invoice sheet are unique. Frame lines are printed in advance on the sheet. To print the invoice, the information processing apparatus 100 generates a print job using information such as the destination input by a user and transmits the print job to the image forming apparatus 110. Next, based on the print job received from the information processing apparatus 100, the image forming apparatus 110 performs printing on the invoice sheet. Although a case is described where printing is performed using the invoice sheet in the present exemplary embodiment, the present disclosure may also be applied to a case where printing is performed using a dedicated sheet used for another purpose.

FIGS. 1BA and 1BB illustrate examples of the configurations of the apparatuses included in the image forming system according to the present exemplary embodiment. FIG. 1BA illustrates hardware configurations of the information processing apparatus 100 and the image forming apparatus 110. First, the information processing apparatus 100 will be described. The information processing apparatus 100 includes a central processing unit (CPU) 101, a memory 102, a random-access memory (RAM) 103, an operation unit 104, a display unit 105, and a transmission/reception unit 106. These components are connected to each other by a system bus 109.

The CPU 101 controls the general operation of the information processing apparatus 100. Processing of the information processing apparatus 100 in processing illustrated in a sequence diagram described below is carried out by the CPU 101 loading programs stored in the memory 102 into the RAM 103 and running the programs. The memory 102 is a readable and writable memory such as a hard disk drive (HDD) or a solid-state drive (SSD) and stores an operating system (OS), various programs, and various pieces of data. The RAM 103 is a volatile random-access memory. The RAM 103 functions as a work area for the CPU 101 and is also used as a temporary storage area for various pieces of data. The operation unit 104 is, for example, a keyboard, a mouse, or a touch panel and provides input information received through operations of the user to the CPU 101. The display unit 105 is, for example, a display and displays a screen based on operations of the user on the operation unit 104 or displays information for the user under control of the CPU 101. If the information processing apparatus 100 is a PC, the display unit 105 may be externally connected to the information processing apparatus 100. The transmission/reception unit 106 transmits and receives information to and from an external device under control of the CPU 101. In the present exemplary embodiment, the transmission/reception unit 106 communicates with the image forming apparatus 110 via the network 120 and transmits and receives various pieces of data to and from the image forming apparatus 110.

Next, the image forming apparatus 110 will be described. The image forming apparatus 110 includes a CPU 111, a ROM 112, a RAM 113, an operation unit 114, a display unit 115, a transmission/reception unit 116, a non-volatile memory 117, an engine interface (I/F) 118, and a printer engine 119.

These components are connected to one another via a system bus 130.

The CPU 111 controls the general operation of the image forming apparatus 110. Processing of the image forming apparatus 110 in the processing illustrated in the sequence diagram described below is carried out by the CPU 111 loading programs stored in the ROM 112 or the non-volatile memory 117 into the RAM 113 and running the programs. Processing regarding a flowchart described below is carried out by the CPU 111 loading programs stored in the ROM 112 or the non-volatile memory 117 into the RAM 113 and running the programs. The ROM 112 stores programs that can be run by the CPU 111. The ROM 112 also stores various pieces of data such as font data. The RAM 113 functions as a work area for the CPU 111 and is also used as a temporary storage area for various pieces of data.

The operation unit 114 provides input information received through operations of the user to the CPU 111.

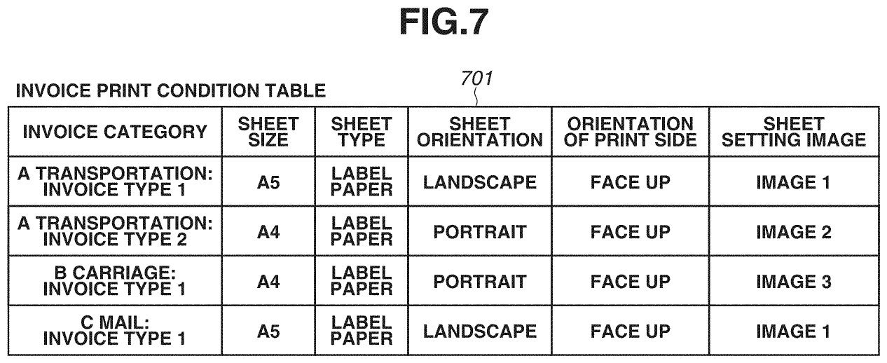

The display unit 115 displays a screen based on operations of the user on the operation unit 114 or displays information for the user under control of the CPU 111. The operation unit 114 and the display unit 115 may be a touch panel display having both the functions of an operation unit and a display unit. The transmission/reception unit 116 transmits and receives information to and from an external device under control of the CPU 111. In the present exemplary embodiment, the transmission/reception unit 116 communicates with the information processing apparatus 100 via the network 120 and transmits and receives various pieces of data to and from the information processing apparatus 100. The non-volatile memory 117 stores image data, print data, various programs, various pieces of setting information, and an invoice print condition table (FIG. 7) described below. Although a flash memory is assumed as the non-volatile memory 117 in the present exemplary embodiment, an auxiliary storage device such as an SSD, an HDD, or an embedded MultiMediaCard (eMMC) may be used.

The engine I/F 118 connects the printer engine 119 and the CPU 111. The printer engine 119 includes sheet feeding units (not illustrated) such as sheet feeding cassettes and a manual-bypass tray. The CPU 111 transfers image data to be printed (image data as a printing target) to the printer engine 119 via the engine I/F 118. The printer engine 119 prints the image data on a sheet fed from one of the sheet feeding units, using toner supplied from a cartridge(s) (not illustrated). Although an example is described where an image is formed on a sheet by an electrophotographic method in the present exemplary embodiment, the image forming method is not limited to the electrophotographic method, and another method such as an inkjet method may be employed.

In the image forming apparatus 110, a single CPU 111 performs the processing illustrated in the flowchart described below using a single memory (the RAM 113). Alternatively, another form may be used. For example, a plurality of CPUs, RAMs, ROMs, and spaces of storage can also cooperate to perform the processing illustrated in the flowchart described below. A part of the processing may be performed using a hardware circuit such as an application-specific integrated circuit (ASIC) or a field-programmable gate array (FPGA).

FIG. 1BB illustrates a software configuration of the information processing apparatus 100. The information processing apparatus 100 includes a printer driver 107 and an invoice creation app 108 as software modules. The functions of the printer driver 107 and the invoice creation app 108 are implemented by the CPU 101 running programs stored in the memory 102.

The printer driver 107 performs processing for the image forming apparatus 110 to print drawing data generated by various applications such as the invoice creation app 108 included in the information processing apparatus 100. The printer driver 107 sets items (the sheet size, the sheet type, and the image quality setting) to perform printing. Further, the printer driver 107 converts drawing data generated by various applications such as the invoice creation app 108 into image data to be printed by the image forming apparatus 110 and transmits the image data together with print setting information in which the setting values of the items for printing are stored, as a print job to the image forming apparatus 110. In the present exemplary embodiment, the printer driver 107 is a versatile printer driver that can be used for printing other than the printing of the invoice. The printer driver 107 can set an item indicating whether the invoice is to be printed. Hereinafter, a print job for which the item indicating whether the invoice is to be printed is set to ON will be referred to as an “invoice print job”.

The invoice creation app 108 is an application for inputting and generating data to be printed on the invoice. The invoice sheet differs in format among carrying companies such as A Transportation, B Carriage, or C Mail. Thus, the invoice creation app 108 may be composed of a plurality of applications for the respective carrying companies. In the present exemplary embodiment, the invoice creation app 108 is composed of a single application used in common among a plurality of carrying companies. There are a plurality of types of invoice sheet even for a carrying company. To deal with the types, an identifier capable of identifying a carrying company name and an invoice type is assigned as an invoice category. An invoice category is set for an invoice print job, whereby the image forming apparatus 110 can identify the invoice category of the invoice print job. In the present exemplary embodiment, the printer driver 107 sets an invoice category when setting an invoice print job. As the invoice category, a character string of a combination of the carrying company name and the invoice type, such as “A Transportation: invoice type 1”, may be used, or an allocated sign such as “1” for “A Transportation: invoice type 1” or “2” for “A Transportation: invoice type 2” may be used.

### <Sequence for Transmitting Invoice Print Job>

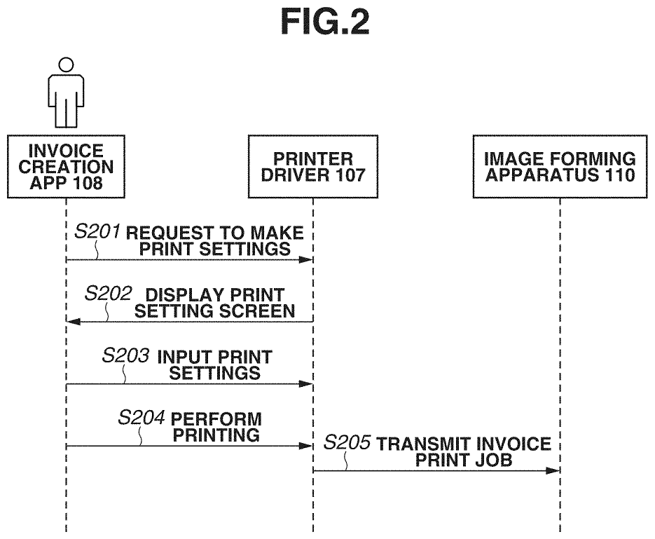

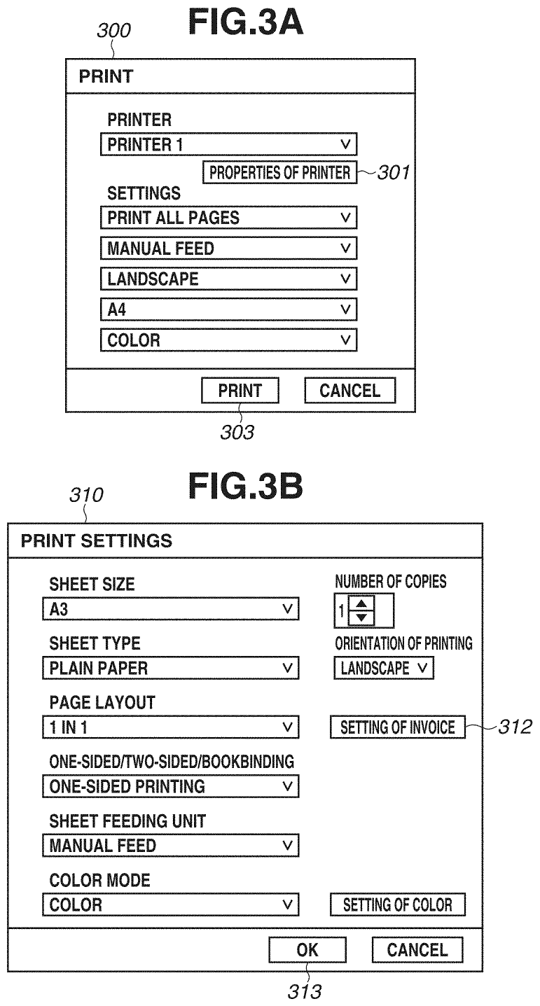

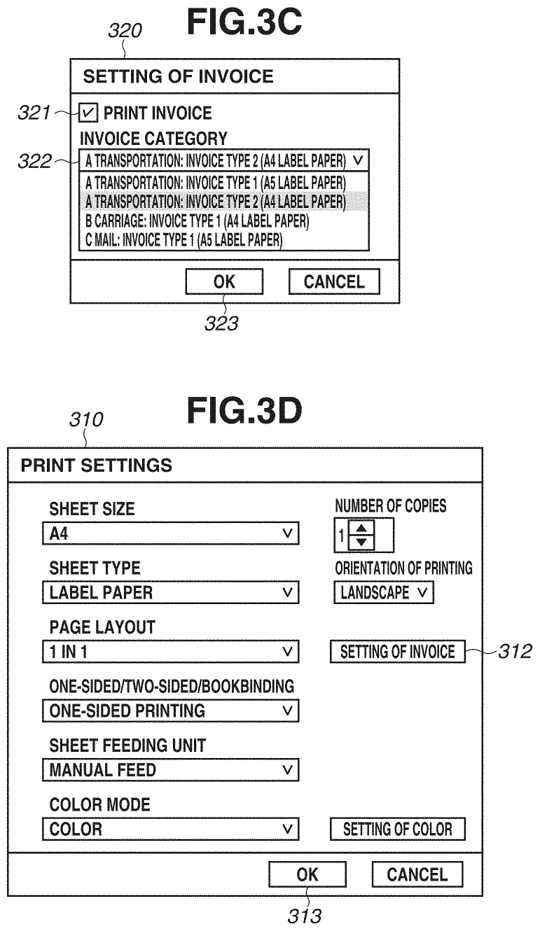

Next, with reference to FIG. 2 and FIGS. 3A to 3D, a description is given of processing performed by the information processing apparatus 100 and the image forming apparatus 110. FIG. 2 illustrates a sequence in which the information processing apparatus 100 transmits an invoice print job to the image forming apparatus 110 according to the present exemplary embodiment. FIGS. 3A to 3D illustrate examples of display of screens displayed on the display unit 105 of the information processing apparatus 100 when the invoice print job is set. In the following description, the printer driver 107 and the invoice creation app 108 are represented as operation subjects. Specifically, the CPU 101 of the information processing apparatus 100 performs processing following the printer driver 107 and the invoice creation app 108.

The user inputs information such as a destination to a screen provided by the invoice creation app 108 via the operation unit 104 of the information processing apparatus 100, whereby the invoice creation app 108 generates drawing data to be printed on the invoice. If the user gives an instruction to print the invoice, the invoice creation app 108 displays a print screen on the display unit 105. FIG. 3A illustrates an example of display of the print screen.

On a print screen 300 illustrated in FIG. 3A, an area for displaying and selecting a printer to perform printing and an area for displaying and selecting the setting details of items for printing are provided. In the present exemplary embodiment, the image forming apparatus 110 is selected as a printer to perform printing.

On the print screen 300, a property button 301 for displaying and selecting the setting details of items that are not displayed on the print screen 300 is provided. If the user presses the property button 301 on the print screen 300, then in step S201, the invoice creation app 108 requests the printer driver 107 to make print settings.

In step S202, the printer driver 107 that has received the request to make print settings displays a print setting screen on the display unit 105. FIG. 3B illustrates an example of display of the print setting screen. In step S203, based on settings selected on the print setting screen illustrated in FIG. 3B, the printer driver 107 makes print settings. On a print setting screen 310 illustrated in FIG. 3B, areas for displaying and selecting the setting details of items such as the sheet size and the sheet type are provided. On the print setting screen 310, a “setting of invoice” button 312 for setting the invoice is also provided. If the user presses the “setting of invoice” button 312 on the print setting screen 310, the printer driver 107 displays a “setting of invoice” screen on the display unit 105. FIG. 3C illustrates an example of display of the “setting of invoice” screen.

On a “setting of invoice” screen 320 illustrated in FIG. 3C, a checkbox 321 is provided. If the checkbox 321 is checked, the printer driver 107 sets an item indicating whether a print job to be generated by the printer driver 107 is an invoice print job (hereinafter referred to as an “invoice print flag”) to ON. Before the checkbox 321 is checked, user interface (UI) components provided on the “setting of invoice” screen 320 are grayed out, leading input to be disabled. If the checkbox 321 is checked, the graying out is cleared, leading input to be enabled. On the “setting of invoice” screen 320, an area 322 for displaying and selecting an invoice category is provided.

If a pull-down button in the area 322 is operated, a list of invoice categories is displayed in a selectable manner as in “A Transportation: invoice type 1” and “B Carriage: invoice type 1”. If an invoice category as an option is displayed with the carrying company name and the invoice type alone, it is confusing to the user when selecting the invoice category. Thus, the sheet size and the sheet type are displayed in parenthesis as in “A Transportation: invoice type 1 (A5 label paper)” as supplementary information.

In the present exemplary embodiment, invoice categories are registered in advance in the printer driver 107, and based on information regarding the registered invoice categories, the printer driver 107 determines options to be displayed in the area 322. By the printer driver 107 being updated to a version where the invoice categories are updated, an option to be displayed can be added to the area 322. Alternatively, a management server (not illustrated) that manages invoice categories may be provided, and the printer driver 107 may communicate with the management server, acquire invoice categories, and determine options to be displayed in the area 322 based on the acquired invoice categories.

In the present exemplary embodiment, on the “setting of invoice” screen 320, the user selects “A Transportation: invoice type 2 (A4 label paper)” and presses an OK button 323 for finalizing the setting of the invoice. If the OK button 323 is pressed, the printer driver 107 holds the setting value of the invoice print flag and the selected invoice category and displays the print setting screen 310 illustrated in FIG. 3D on the display unit 105. The print setting screen 310 illustrated in FIG. 3D is different from the print setting screen 310 illustrated in FIG. 3B in the display of the sheet size and the sheet type.

This is because “A Transportation: invoice type 2” is selected as an invoice category on the “setting of invoice” screen 320, and in conjunction with the selection, the setting values of the sheet size and the sheet type are changed. If there is no issue with the displayed settings in FIG. 3D, the user presses an OK button 313 for finalizing the setting values of the items.

If the OK button 313 on the print setting screen 310 is pressed, the printer driver 107 holds the setting values of the items displayed on the print setting screen 310. Then, the invoice creation app 108 displays the print screen 300 illustrated in FIG. 3A on the display unit 105 again. If there is no issue with the displayed settings in FIG. 3A, the user presses a “print” button 303 for performing printing. If the “print” button 303 is pressed, then in step S204, the invoice creation app 108 instructs the printer driver 107 to perform printing.

In step S205, the printer driver 107 instructed to perform printing converts drawing data provided by the invoice creation app 108 into image data that can be printed by the image forming apparatus 110. Then, the printer driver 107 generates a print job including the image data and print setting information and transmits the generated print job to the image forming apparatus 110. The print setting information includes the setting value of the invoice print flag and the selected invoice category.

### <Invoice Printing Process>

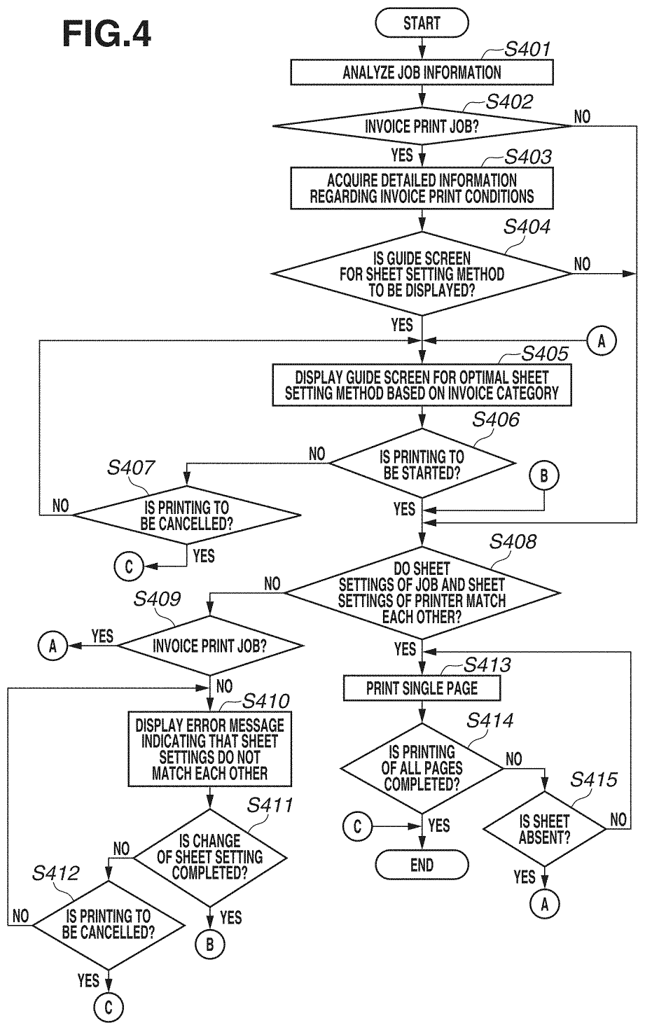

Next, with reference to FIGS. 4 to 8, a description is given of an invoice printing process performed by the image forming apparatus 110 according to the present exemplary embodiment. FIG. 4 is a flowchart illustrating the invoice printing process. Processing of the flowchart illustrated in FIG. 4 is performed after the image forming apparatus 110 receives the invoice print job in step S205 in FIG. 2. Steps illustrated in FIG. 4 are performed by the CPU 111 of the image forming apparatus 110 loading programs stored in the ROM 112 or the non-volatile memory 117 into the RAM 113 and running the programs.

First, if the CPU 111 receives a print job as print data from the information processing apparatus 100, then in step S401, the CPU 111 analyzes the job information regarding the received print job. The job information includes image data as a printing target and print setting information such as the setting value of the invoice print flag. Based on the result of analyzing the job information, the CPU 111 determines what printing is to be performed.

Next, in step S402, based on the result of analyzing the job information, the CPU 111 determines whether the received print job is an invoice print job. In the present exemplary embodiment, if the invoice print flag included in the job information is set to ON, the CPU 111 determines that the received print job is an invoice print job. The determination of whether the received print job is an invoice print job may be made using another method. For example, the sheet name “A Transportation: invoice type 1” may be registered in advance as the name of the invoice in the image forming apparatus 110, and if a sheet name included in the job information is “A Transportation: invoice type 1”, it may be determined that the received print job is an invoice print job. Alternatively, if a file name included in the job information is the same as a file name registered in advance, it may be determined that the received print job is an invoice print job. If the CPU 111 determines that the received print job is an invoice print job (Yes in step S402), the processing proceeds to step S403. If the CPU 111 determines that the received print job is not an invoice print job (No in step S402), the processing proceeds to step S408.

In step S403, the CPU 111 references an invoice print condition table stored in the non-volatile memory 117 and acquires print conditions corresponding to an invoice category included in the job information.

FIG. 7 illustrates an example of the invoice print condition table. An invoice print condition table 701 in FIG. 7 holds print conditions including the sheet size, the sheet type, the orientation of the sheet, the orientation of the print side, and a sheet setting image in association with an invoice category. In the present exemplary embodiment, print conditions associated with “A Transportation: invoice type 2” are acquired. In the example illustrated in FIG. 7, the sheet size =“A4”, the sheet type=“label paper”, the sheet orientation=“portrait”, the orientation of the print side=“face up”, and the sheet setting image=“image 2” are acquired as the print conditions. The sheet setting image is an image for guiding the user through a correct setting method for setting the invoice sheet and is displayed on the display unit 115 of the image forming apparatus 110 after the job is analyzed.

Even if the sheet is similarly set, whether printing is to be performed on the top side of the sheet or printing is to be performed on the back side of the sheet depends on a sheet conveying path in the image forming apparatus 110 and the configurations of a developing device and a photosensitive drum (not illustrated) for performing printing. Thus, the orientation of the print side is managed for each model depending on the apparatus configuration of the image forming apparatus 110. The sheet setting image is also managed for each model of the image forming apparatus 110 in view of an appropriate orientation of the print side. By updating a program for controlling the operation of the image forming apparatus 110 to a version where the invoice categories are updated, an invoice category to be held can be added to the invoice print condition table 701. Alternatively, similarly to the example of the printer driver 107, a management server (not illustrated) that manages invoice categories may be provided, and the image forming apparatus 110 may communicate with the management server, acquire invoice categories, and update the invoice print condition table 701 based on the acquired invoice categories.

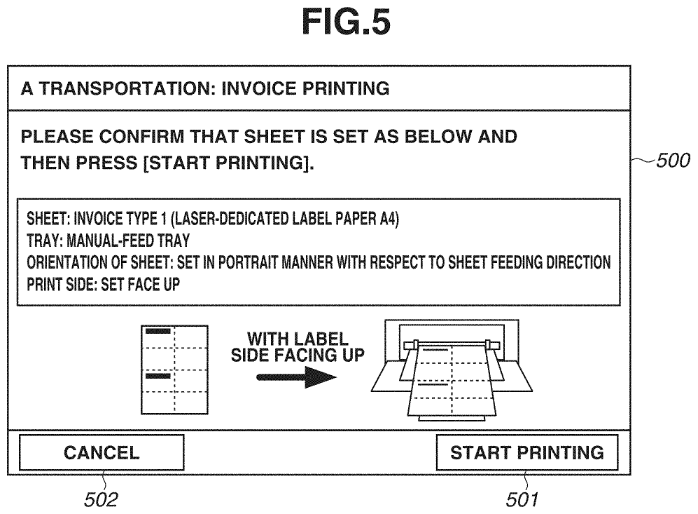

In step S404, the CPU 111 determines whether a guide screen for guiding the user through the correct setting method for setting the invoice sheet is to be displayed on the display unit 115. FIG. 5 illustrates an example of display of the guide screen. FIG. 5 will be described below. In the present exemplary embodiment, the non-volatile memory 117 stores setting information indicating whether to display the guide screen, as the display setting of the guide screen. Based on the display setting of the guide screen, the CPU 111 determines whether the guide screen is to be displayed on the display unit 115. If the CPU 111 determines that the guide screen is to be displayed (Yes in step S404), the processing proceeds to step S405. If the CPU 111 determines that the guide screen is not to be displayed (No in step S404), the processing proceeds to step S408.

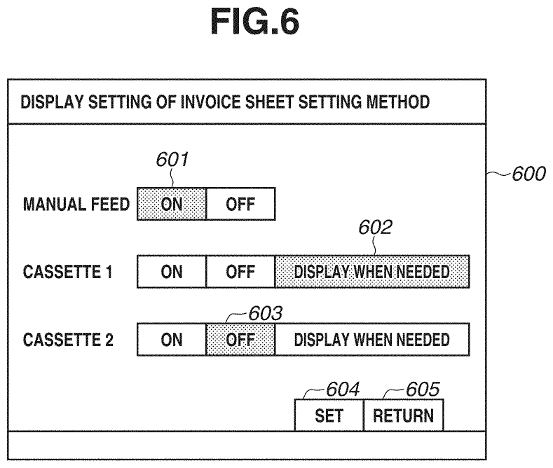

FIG. 6 illustrates an example of display of a setting screen for the display setting of the guide screen. A setting screen 600 in FIG. 6 is displayed on the display unit 115 under control of the CPU 111 when a management screen of the image forming apparatus 110 is displayed. On the setting screen 600, the display setting for each sheet feeding unit can be changed by an operation of the user. FIG. 6 illustrates an example of a case where a manual-feed tray and sheet feeding cassettes 1 and 2 can be used as a sheet feeding unit. If an option cassette is additionally connected to the image forming apparatus 110, the added sheet feeding cassette such as a sheet feeding cassette 3 or 4 is also displayed so that the display setting for the added sheet feeding cassette can be changed.

In an area 601 in FIG. 6, “ON” is selected as the display setting of the guide screen when the manual-feed tray is used. If the display setting regarding a sheet feeding unit specified in the job information is “ON”, the CPU 111 determines that the guide screen is to be displayed. Then, the CPU 111 performs control to display the guide screen on the display unit 115. On the other hand, in an area 603 in FIG. 6, “OFF” is selected as the display setting of the guide screen when the sheet feeding cassette 2 is used. If the display setting regarding the sheet feeding unit specified in the job information is “OFF”, the CPU 111 determines that the guide screen is not to be displayed. Then, the CPU 111 performs control not to display the guide screen on the display unit 115. It is considered that a user who frequently prints invoices can correctly set an invoice sheet without confirming the guide screen. Thus, the display of the guide screen may be cumbersome for such a user and may conversely reduce work efficiency. Consequently, the display setting of the guide screen is “OFF” for such a user, preventing the guide screen from being displayed.

Although an example is illustrated where the image forming apparatus 110 holds the display setting of the guide screen in the present exemplary embodiment, the print setting information transmitted from the printer driver 107 may include the display setting of the guide screen. For example, on the “setting of invoice” screen 320 in FIG. 3C, a button for displaying the setting screen for the display setting of the guide screen is separately provided. Then, if the button is pressed, the printer driver 107 displays a screen as illustrated in FIG. 6 and receives the selection of the display setting of the guide screen. As a result, each user can select whether to display the guide screen.

In an area 602 in FIG. 6, “display when needed” is selected as the display setting of the guide screen when the sheet feeding cassette 1 is used. If the display setting regarding the sheet feeding unit specified in the job information is “display when needed” and a predetermined condition is satisfied, the CPU 111 determines that the guide screen is to be displayed. The “predetermined condition” as used herein refers to, for example, a case where the sheet is not set in the sheet feeding unit (the sheet is absent), or a case where the sheet size and the sheet orientation of the sheet set in the sheet feeding unit do not match the sheet size and the sheet orientation included in the print conditions acquired in step S403. On the other hand, if the display setting is “display when needed” and the predetermined condition is not satisfied, the CPU 111 determines that the guide screen is not to be displayed.

In the present exemplary embodiment, a sensor that detects the presence or absence of the set sheet and a sensor that distinguishes the sheet size and the sheet orientation are provided in each of the sheet feeding cassettes 1 and 2. Based on information provided by each sensor, the CPU 111 determines whether the predetermined condition is satisfied.

In the manual-feed tray, a sensor that detects the presence or absence of the sheet is provided, and a sensor that distinguishes the sheet size and the sheet orientation is not provided. Thus, in the example of FIG. 6, regarding the sheet feeding cassettes 1 and 2, “display when needed” is displayed in a selectable manner, but regarding the manual-feed tray, “display when needed” is hidden and cannot be selected. As described above, whether to display “display when needed” regarding each of the sheet feeding units is managed based on the apparatus configuration of the image forming apparatus 110.

If a “set” button 604 is pressed on the setting screen 600 in FIG. 6, the CPU 111 changes the display setting with the selected settings and closes the setting screen 600. If, on the other hand, a “return” button 605 is pressed, the CPU 111 discards the selected settings and closes the setting screen 600.

The description returns to FIG. 4. In step S405, the CPU 111 displays on the display unit 115 the guide screen for guiding the user through the correct setting method for setting the invoice sheet. In the present exemplary embodiment, based on the invoice category as category information included in the job information, the CPU 111 determines the contents of the guide screen. That is, the CPU 111 differentiates the contents of the guide screen with respect to each invoice category set by the printer driver 107. In this case, the guide screen generated using the print conditions acquired in step S403 is displayed. As illustrated in FIG. 5, on a guide screen 500, information regarding the sheet feeding unit specified in the job information, the size of the sheet, the type of the sheet, the orientation of the sheet, and the orientation of the print side is displayed in text and images according to a procedure for setting the invoice sheet. As described above, the guide screen is displayed on the screen of the printer, allowing the user to set the invoice sheet while confirming the correct setting method on the spot.

Next, in step S406, the CPU 111 determines whether an instruction to start printing is given by an operation of the user. As illustrated in FIG. 5, on the guide screen 500 displayed in step S405, a “start printing” button 501 for giving an instruction to start printing is provided. If the “start printing” button 501 is pressed, an instruction to start printing is given. The determination of whether an instruction to start printing is given may be made using another method. For example, if the CPU 111 detects a change that the state where the sheet is absent transitions to the state where the sheet is present, based on information provided by a sensor that detects the presence or absence of the sheet, it may be determined that an instruction to start printing is given.

Alternatively, based on the fact that the CPU 111 determines that the sheet size and the sheet orientation of the set sheet match the sheet size and the sheet orientation included in the print conditions acquired in step S403, it may be determined that an instruction to start printing is given. If it is determined that an instruction to start printing is given based on the determination that the sheet is correctly set, the CPU 111 skips step S408, and the processing proceeds to step S413. If the CPU 111 determines that an instruction to start printing is given (Yes in step S406), the CPU 111 closes the guide screen 500 in FIG. 5, and the processing proceeds to step S408. If the CPU 111 determines that an instruction to start printing is not given (No in step S406), the processing proceeds to step S407.

In step S407, the CPU 111 determines whether an instruction to cancel printing is given by an operation of the user. As illustrated in FIG. 5, on the guide screen 500 displayed in step S405, a “cancel” button 502 for giving an instruction to cancel printing is provided. If the “cancel” button 502 is pressed, an instruction to cancel printing is given. Alternatively, it may be determined whether an instruction to cancel the job is given on another screen. If the CPU 111 determines that an instruction to cancel printing is not given (No in step S407), the processing returns to step S405. If the CPU 111 determines that an instruction to cancel printing is given (Yes in step S407), the CPU 111 performs a job cancellation process, and the sequential procedure ends.

In step S408, the CPU 111 determines whether the sheet settings included in the job information and the settings of the sheet feeding unit specified in the job information match each other. The CPU 111 may determine whether the sheet size and the sheet type included in the print conditions acquired in step S403 and the settings of the sheet feeding unit specified in the job information match each other. If the CPU 111 determines that the sheet settings and the settings of the sheet feeding unit do not match each other (No in step S408), the processing proceeds to step S409. If the CPU 111 determines that the sheet settings and the settings of the sheet feeding unit match each other (Yes in step S408), the processing proceeds to step S413.

In step S409, the CPU 111 determines whether the print job that is being performed is an invoice print job. If the CPU 111 determines that the print job is not an invoice print job (is a normal print job) (No in step S409), the processing proceeds to step S410. If the CPU 111 determines that the print job is an invoice print job (Yes in step S409), the processing returns to step S405. In step S405, the CPU 111 displays the guide screen 500 in FIG. 5. Consequently, even if the user gives an instruction to start printing in the state where the sheet is set by an incorrect method, the correct setting method for setting the sheet is displayed, allowing the user to set the invoice sheet while confirming the correct setting method on the spot and give an instruction to start printing again.

If, however, the guide screen 500 in FIG. 5 is displayed in step S405, the user is less likely to mistake the setting method for setting the sheet. Thus, if the guide screen 500 in FIG. 5 is displayed in step S405, the CPU 111 may skip step S408, and the processing may proceed to step S413. Alternatively, based on the display setting of the guide screen, the CPU 111 may switch whether to skip step S408. Specifically, if the display setting regarding the sheet feeding unit to be used in printing is “OFF”, the CPU 111 carries out the process of step S408. If the display setting is other than “OFF”, the CPU 111 skips step S408. If the print job is a normal print job, the CPU 111 performs control to carry out the process of step S408.

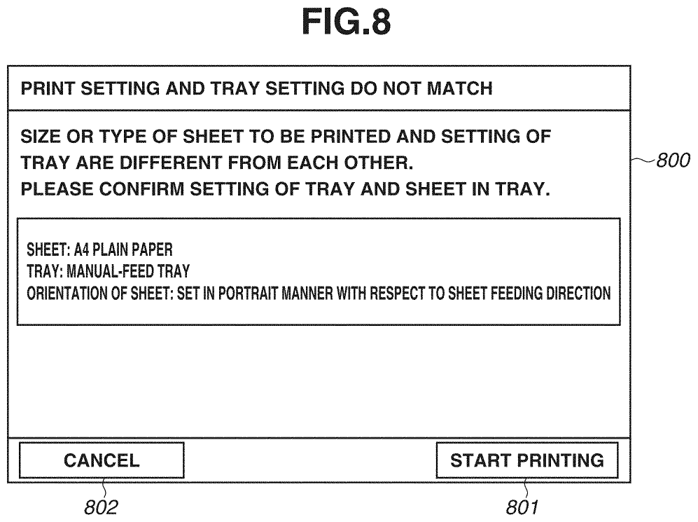

In step S410, the CPU 111 displays on the display unit 115 a confirmation screen for the user to confirm that the sheet settings included in the job information and the settings of the sheet feeding unit specified in the job information do not match each other. FIG. 8 illustrates an example of display of the confirmation screen displayed in step S410. A confirmation screen 800 illustrated in FIG. 8 displays a message notifying the user that the sheet size or the sheet type of the sheet to be subjected to printing and the setting of the sheet feeding unit (the manual-feed tray in this case) do not match each other. This can urge the user to confirm the setting of the sheet feeding unit and the actually set sheet.

Next, in step S411, the CPU 111 determines whether a change is made so that the sheet settings included in the job information and the settings of the sheet feeding unit specified in the job information will match each other. In the present exemplary embodiment, if a “start printing” button 801 on the confirmation screen 800 in FIG. 8 is pressed, it is determined that the change is made. If the CPU 111 determines that the change is made (Yes in step S411), the processing returns to step S408. If the CPU 111 determines that the change is not made (No in step S411), the processing proceeds to step S412.

In step S412, the CPU 111 determines whether an instruction to cancel printing is given by an operation of the user. In the present exemplary embodiment, if a “cancel” button 802 on the confirmation screen 800 in FIG. 8 is pressed, an instruction to cancel printing is given. If the CPU 111 determines that an instruction to cancel printing is not given (No in step S412), the processing returns to step S410. If the CPU 111 determines that an instruction to cancel printing is given (Yes in step S412), the CPU 111 performs the job cancellation process, and the sequential procedure ends.

In step S413, the CPU 111 prints a single page of the invoice using the printer engine 119.

Next, in step S414, the CPU 111 determines whether the printing of all the pages is completed. If the CPU 111 determines that the printing of all the pages is completed (Yes in step S414), the printing process is completed, and the sequential procedure ends. If the CPU 111 determines that there is a page that has not yet been printed (No in step S414), the processing proceeds to step S415.

In step S415, the CPU 111 determines whether a sheet is present or absent in the sheet feeding unit used in printing. If the CPU 111 determines that a sheet is present (Yes in step S415), the processing returns to step S413. In step S413, the CPU 111 prints the remaining page. If the CPU 111 determines that any sheet is absent (No in step S415), the processing returns to step S405. In step S405, the CPU 111 displays the guide screen 500 in FIG. 5. Then, the CPU 111 repeats the processes of steps S406 to S414 and prints the remaining page.

According to the first exemplary embodiment, when an invoice is printed, a guide for a correct setting method for setting an invoice sheet can be displayed on the display unit 115 of the image forming apparatus 110. Consequently, the user can set the invoice sheet while confirming the correct setting method on the spot. Thus, the configuration described above prevents the occurrence of an error in printing due to an incorrect sheet setting method.

Although a description has been given of an example where the printer driver 107 is a versatile printer driver in the present exemplary embodiment, the printer driver 107 may be a printer driver dedicated to the invoice. This eliminates the need for the user to make a setting for indicating that a print job is an invoice print job on the printer driver. The information processing apparatus 100 transmits a print job generated by the printer driver dedicated to the invoice as an invoice print job to the image forming apparatus 110. Regarding an invoice category, a configuration may be employed in which an invoice category is selected in installation of the printer driver dedicated to the invoice, and the fixed invoice category is set when printing is performed, thereby eliminating the need for the user to select an invoice category.

As a first variation of the present exemplary embodiment, after step S402 in the flowchart in FIG. 4, the CPU 111 determines whether there is a sheet feeding cassette for which the same name as that of an invoice category included in the job information is set. If the CPU 111 determines that there is a sheet feeding cassette for which the same name is set, the processing proceeds to step S413. This is because if there is a sheet feeding cassette for which the same invoice category as the invoice category set in the printer driver 107 is set, it can be determined that the invoice sheet is also appropriately set. If the CPU 111 determines that there is not a sheet feeding cassette for which the same name is set, the processing proceeds to step S403.

A second exemplary embodiment will be described. In the first exemplary embodiment, a case has been described where the invoice creation app 108 generates drawing data to be printed while the printer driver 107 makes settings regarding the printing of the invoice such as the setting of the invoice print flag. In the second exemplary embodiment, a case will be described where the invoice creation app 108 also makes settings regarding the printing of the invoice, and the printer driver 107 does not make settings regarding the printing of the invoice.

### <Sequence for Transmitting Invoice Print Job>

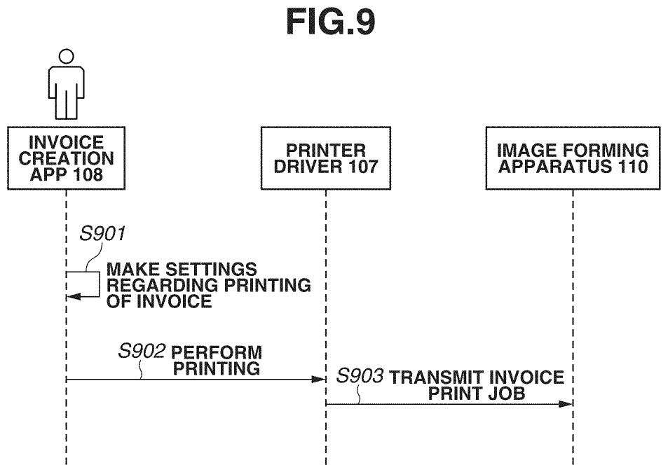

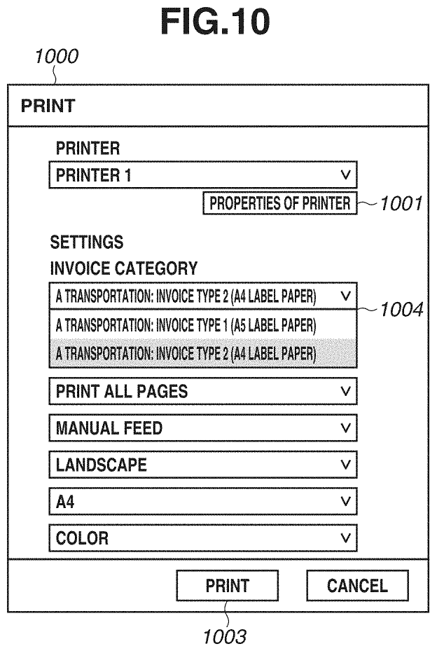

FIG. 9 illustrates a sequence in which the information processing apparatus 100 transmits an invoice print job to the image forming apparatus 110 according to the present exemplary embodiment. FIG. 10 illustrates an example of display of a screen displayed on the display unit 105 of the information processing apparatus 100 when the invoice print job is set.

In the present exemplary embodiment, the invoice creation app 108 generates drawing data to be printed on the invoice and makes settings regarding the printing of the invoice, and the printer driver 107 transmits an invoice print job to the image forming apparatus 110. The differences from the first exemplary embodiment will be mainly described.

If the user gives an instruction to print the invoice, then in step S901, the invoice creation app 108 displays a print screen on the display unit 105 and makes settings regarding the printing of the invoice. FIG. 10 illustrates an example of display of the print screen. On a print screen 1000 illustrated in FIG. 10, an area 1004 for displaying and selecting an invoice category is additionally provided compared with the print screen 300 in FIG. 3A. If a pull-down button in the area 1004 is operated, a list of invoice categories is displayed in a selectable manner as in “A Transportation: invoice type 1” and “A Transportation: invoice type 2”. The present exemplary embodiment is described on the assumption that the invoice creation app 108 is an application dedicated to A Transportation. Thus, in the area 1004, a list of invoice categories of A Transportation alone is displayed. However, if the invoice creation app 108 is not an application dedicated to a specific carrying company, but is an application used common among a plurality of carrying companies, a list of invoice categories of other carrying companies is also displayed. The setting values of items such as the size of the sheet, the orientation of the sheet, and whether to perform color printing or monochrome printing are changed in conjunction with an invoice category selected in the area 1004. Similarly to the first exemplary embodiment, if the user presses a property button 1001, the printer driver 107 displays a print setting screen. The print setting screen displayed in this case is similar to that in the first exemplary embodiment except that the “setting of invoice” button 312 is unnecessary. Using the displayed print setting screen also allows setting of items that are not displayed on the print screen 1000.

If there is no issue with the displayed settings in FIG. 10, the user presses a “print” button 1003 for performing printing. If the “print” button 1003 is pressed, then in step S902, the invoice creation app 108 instructs the printer driver 107 to perform printing. In this case, the invoice creation app 108 provides drawing data and the setting values of the items displayed on the print screen 1000 as print setting information to the printer driver 107. The print setting information also includes the setting value of the invoice print flag, the selected invoice category, and sheet settings associated with the invoice category.

In step S903, the printer driver 107 instructed to perform printing generates an invoice print job using the information provided by the invoice creation app 108 in step S902 and transmits the generated invoice print job to the image forming apparatus 110.

The image forming apparatus 110 that has received the invoice print job carries out an invoice printing process similar to that in the flow illustrated in FIG. 4. In this case, in step S402 in FIG. 4, if application information regarding the invoice creation app 108 that has made settings regarding the invoice print job is included in the job information, the image forming apparatus 110 may determine that the received invoice print job is an invoice print job.

According to the second exemplary embodiment, settings can be made regarding the printing of an invoice using the invoice creation app 108 and transmit an invoice print job to the image forming apparatus 110 via the printer driver 107. In the present exemplary embodiment, an example has been described where an invoice print job is transmitted via the printer driver 107 so that the image forming apparatus 110 can analyze job information. Alternatively, the invoice creation app 108 may generate an invoice print job so that the image forming apparatus 110 can analyze job information, and directly transmit the invoice print job to the image forming apparatus 110 not via the printer driver 107.

While the present disclosure has been described above together with the exemplary embodiments, the above exemplary embodiments merely illustrate specific examples for carrying out the present disclosure, and the technical scope of the present disclosure should not be interpreted in a limited manner based on these exemplary embodiments. That is, the present disclosure can be carried out in various ways without departing from the technical idea or the main feature of the present disclosure. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-189279, filed Nov. 22, 2021, which is hereby incorporated by reference herein in its entirety.

What is claimed is:

1. An image forming apparatus comprising:
a reception unit configured to receive print data; and
a control unit configured to perform control to display, on a display unit, a sheet setting method for setting a sheet to be used to print the print data, based on a state where a predetermined setting is included in the received print data.

2. The image forming apparatus according to claim 1, wherein, based on category information regarding the predetermined setting included in the received print data, the control unit determines the sheet setting method to be displayed on the display unit.

3. The image forming apparatus according to claim 2, further comprising:
a storage unit configured to store a print condition to be used in printing in association with the category information; and
an acquisition unit configured to acquire, from the storage unit, a print condition corresponding to the category information included in the received print data,
wherein, based on the acquired print condition, the control unit determines the sheet setting method to be displayed on the display unit.

4. The image forming apparatus according to claim 1, further comprising a setting unit configured to set whether to display the sheet setting method,
wherein, based on the setting made by the setting unit, the control unit controls whether to display the sheet setting method.

5. The image forming apparatus according to claim 1, wherein, based on a state where a setting of a sheet feeding unit specified in the received print data does not match a sheet setting included in the received print data, the control unit performs control to display the sheet setting method on the display unit.

6. The image forming apparatus according to claim 1, wherein, in a case where the sheet setting method is displayed, the control unit performs control to start printing the print data, regardless of whether a setting of a sheet feeding unit specified in the received print data and a sheet setting included in the received print data match each other.

7. The image forming apparatus according to claim 1, wherein, in a case where there is a sheet feeding unit for which a sheet name is set and is the same sheet name as a sheet name included in the received print data, the control unit performs control to start printing the print data without displaying the sheet setting method.

8. The image forming apparatus according to claim 1, wherein the control unit performs control to display, on the display unit, information indicating a sheet feeding unit specified in the received print data, a size of the sheet to be used to print the print data, a type of the sheet, an orientation of the sheet, and an orientation of a print side as the sheet setting method.

9. The image forming apparatus according to claim 1, wherein the predetermined setting is a setting indicating printing of an invoice adapted to a format specific to a carrying company.

10. An image forming system comprising:
an information processing apparatus that includes a generation unit configured to generate print data, and a transmission unit configured to transmit the print data to the image forming apparatus; and
an image forming apparatus, wherein the image forming apparatus includes:
a reception unit configured to receive print data, and
a control unit configured to perform control to display, on a display unit, a sheet setting method for setting a sheet to be used to print the print data, based on a state where a predetermined setting is included in the received print data.

11. The image forming system according to claim 10,
wherein the information processing apparatus further includes an application configured to generate image data to be used in printing, and a printer driver configured to convert the generated image data into the generated print data, and
wherein, based on an operation of a user on a setting screen displayed using the printer driver, the generation unit includes the predetermined setting in the generated print data.

12. The image forming system according to claim 10,
wherein the information processing apparatus further includes an application configured to generate image data to be used in printing for a predetermined purpose, and a printer driver configured to convert the generated image data into the generated print data, and
wherein, based on the image data generated by the application, the generation unit includes the predetermined setting in the generated print data.

13. A non-transitory computer-readable storage medium storing a program to cause a computer to perform a method for an image forming apparatus, the method comprising:
receiving print data; and
performing control to display, on a display, a sheet setting method for setting a sheet to be used to print the print data, based on a state where a predetermined setting is included in the received print data.
